(19) United States
(12) Patent Application Publication
(10) Pub. No.: US 2015/0149962 A1
(43) Pub. Date: May 28, 2015

(54) USER INTERFACE TECHNIQUES FOR CONDENSED DISPLAY OF DATA

(71) Applicants: Daniel Jakobs, Ettlingen-Bruchhausen (DE); Eduard Hess, Wiesloch (DE); Sonja Zscherpel, Muehlhausen (DE)

(72) Inventors: Daniel Jakobs, Ettlingen-Bruchhausen (DE); Eduard Hess, Wiesloch (DE); Sonja Zscherpel, Muehlhausen (DE)

(21) Appl. No.: 14/086,989

(22) Filed: Nov. 22, 2013

(51) Int. Cl. G06F 3/0482; G06F 3/0481

(52) U.S. Cl. CPC G06F 3/0482; G06F 3/04817
USPC 715/815; 715/825

(57) ABSTRACT

Various embodiments for condensed display of data are described herein. A graphical user interface (GUI) comprises a first region including a plurality of graphical filter elements corresponding to respective content types, a grouping option selector, and a second region for displaying content. A graphical filter element comprises a unique icon representing corresponding content type, numeric information related to the corresponding content type, and a name of the corresponding content type. Upon selection of a grouping option using the grouping option selector, the content is displayed in groups in the second region. The groups are ordered in the second region and group indicators represent respective groups in the second region. Upon selection of a particular graphical filter element, content corresponding to the selected graphical filter element is displayed in the second region. The content in the second region is displayed in demarcated content regions corresponding to respective content types.

### BACKGROUND

Data analysis and presentation has applications in several fields. Volume of data continuously increases and it is in the interest of an organization or any stakeholder to have insights into data. Data can be of different types and can from different sources. For example, data can include social media content which can from various social media websites, click streams from web pages or software applications, survey data from several parties, etc., to name a few. The volume of data can be huge and it would be desirable to present voluminous data in a condensed and, yet, informative manner.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating an overview of a graphical user interface, according to one embodiment.

FIG. 2 is a block diagram of a graphical user interface, according to one embodiment.

FIG. 3 is a block diagram of the graphical user interface after selection of graphical filter elements, according to one embodiment.

FIG. 4 is a block diagram of the graphical user interface after selection of a grouping option, according to one embodiment.

FIG. 5 is a block diagram of a graphical user interface including a graphical indicator representing condensed overview of performance indicators, according to one embodiment.

FIG. 6 is a block diagram of the graphical user interface after expanding the graphical indicator, according to one embodiment.

FIG. 7 is a block diagram of the graphical user interface after expanding a selected section, according to one embodiment.

FIG. 8 is a block diagram of a method for displaying data, according to one embodiment

FIG. 9 is a block diagram of an exemplary computer system according to one embodiment.

### DETAILED DESCRIPTION

Embodiments of user interface techniques for condensed display of data are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

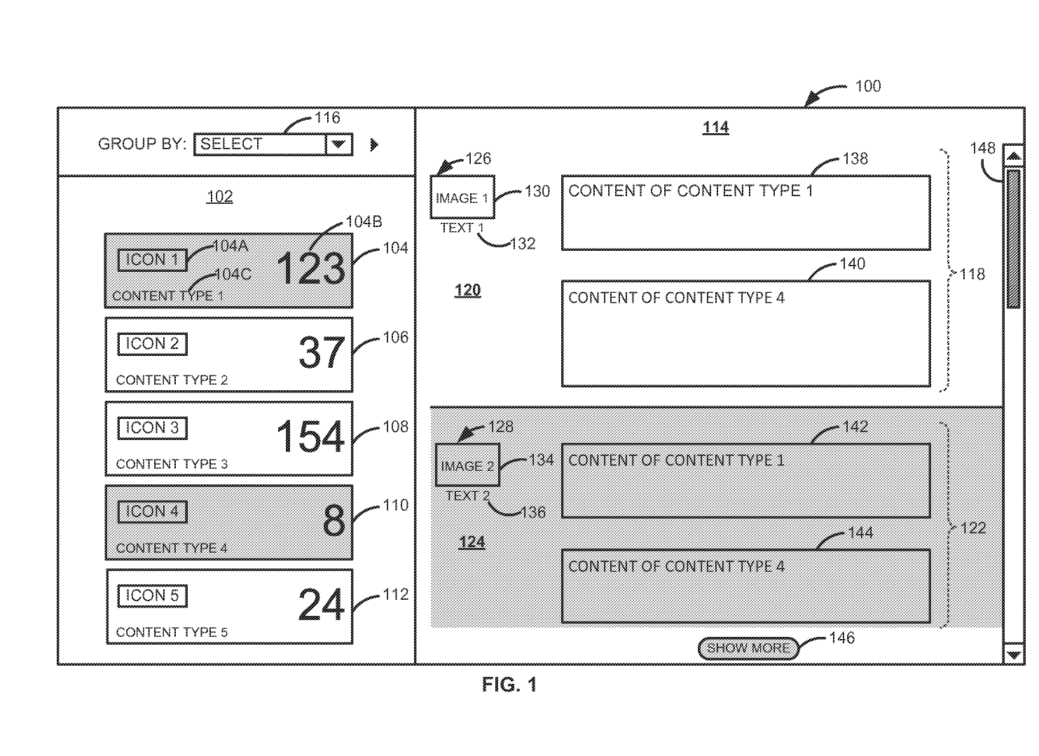

FIG. 1 illustrates an overview of a graphical user interface (GUI) 100, according to one embodiment. The GUI 100 includes a first region 102 including a plurality of graphical filter elements 104-112 and a second region 114 for displaying content. In one embodiment, the first region 102 is on the left-side of the GUI 100 and the second region 114 is on the right-side of the GUI 100. The graphical filter elements 104-112 are arranged linearly, one below the other, in the first region 102. In one embodiment, the graphical filter elements 104-112 are represented as UI tiles. However, other shapes for the graphical filter elements 104-112 are within the scope the embodiments. In one embodiment, each graphical filter element corresponds to a respective content type. For example, a first graphical filter element 104 can correspond to social media content. Even in social media content, the content can vary depending on social media channels. Therefore, in one embodiment, the first graphical filter element 104 can correspond to social media content from a particular social media channel.

A graphical filter element includes a unique icon, numeric information, and a name of the corresponding content type. Considering the first graphical indicator 104, the first graphical indicator 104 includes a unique icon 104A, numeric information 104B, and a name 104C of the corresponding content type. The unique icon 104A visually represents the content type. For example, if the content type is “email,” the unique icon 104A can include a “mail” symbol (not shown). Similarly, if the content type is “social media,” the unique icon 104A can include a logo of the social medial channel (not shown). The numeric information 104B is related to the corresponding content type. In one embodiment, the numeric information 104B represents number of data elements for the respective content type. Different content can include different data elements. For example, for social media content, data element can include “likes” and the numeric information 104B can represent number of “likes.” As another example, for survey content, the numeric information 104B can represent number of completed surveys. The name 104C of the corresponding content type is also included in the first graphical filter element 104. For example, for social media content, the name 104C can include a name of the social medial channel. The unique icon 104A along the name 104C of the content type will enable easy identification of the content type to which the graphical filter element 104 corresponds to. Similarly, other graphical filter elements 106, 108, 110, and 112 include respective unique icons, numeric information, and names of the content types.

The graphical filter elements 104-112 are selectable. Selected graphical filter elements are highlighted to differentiate them from unselected graphical filter elements. In FIG. 1, the first graphical filter element 104 and the fourth graphical filter element 110 are shown as selected and, therefore, highlighted (as represented using the shaded background). The selection of the graphical filter elements will filter the content that is displayed in the second region 114.

The GUI 100 further includes a grouping option selector 116. A grouping option can be selected using the grouping option selector 116. In one embodiment, the grouping option selector 116 includes a drop-down menu including a list of grouping options. The content in the second region 114 is grouped based on the grouping option. For example, if a grouping option “Month” is selected, the content in the second region 114 is grouped according to the month. As another example, the grouping options can include sources or origins of data such as names of people or organizations. In one embodiment, the groups are ordered sequentially in the second region 114, starting from a first group 118. The first group 118 is displayed in a first portion 120 of the second region 114 and a second group 122 is displayed in a second portion 124 of the second region 114 below the first group 120. The curly brackets in the figure are shown to represent the groups but are not part of the GUI. The first portion 120 and second portion 124 are displayed using different UI backgrounds to differentiate the first group 118 and the second group 122. Different UI background techniques such as, but not limited to, shading, use of different colors and textures, can be used. In the GUI 100, the first portion 120 is shown in a plain background and the second portion 124 is shown in a shaded background.

The GUI 100 further includes group indicators 126 and 128 to represent respective groups. A group indicator can include text, an image, or a combination of both. The group indicator 126 of the first group 118 includes text 130 representing the first group 118 and an image 132 representing the first group 118. Similarly, the group indicator 128 of the second group 122 includes text 134 representing the second group 122 and an image 136 representing the second group 122. Considering the previous example of “Month” grouping option, the groups are ordered in chronological order of the months, e.g., starting from January, and a group indicator can include month name and a calendar image. As an example, the first group 118 can include content corresponding to the month “April” and the second group 122 can include content corresponding to the month “May.” The group indicator 126 of the first group 118 can include “April” as the text and a calendar image (not shown). Similarly, the group indicator 128 of the second group 122 can include “May” as the text and a calendar image (not shown).

The content in the second region 114 is displayed in demarcated content regions based on the content type. In a group, there can be content belonging to more than one content type and the content is displayed in demarcated content regions. Consider that the first graphical filter element 104, the fourth graphical filter element 110, and a grouping option are selected. Content belonging to a first content type and a fourth content type and corresponding to the first group is displayed in the first portion 120 of the second region 114. Content belonging to the first content type and the fourth content type and corresponding to the second group is displayed in the second portion 124 of the second region 114. Content belonging to the first content type is displayed in a first demarcated content region 138 of the first portion 120 and content belonging to fourth content type is displayed in a second demarcated content region 140 of the first portion 120. Similarly, content belonging to the first content type is displayed in a first demarcated content region 142 of the second portion 124 and content belonging to fourth content type is displayed in a second demarcated content region 144 of the second portion 124.

In one embodiment, when the content of the groups cannot be fully displayed in the second region, some groups can be hidden and an option 146 to show the hidden groups is provided. For example, in the GUI, consider that third and fourth groups cannot be displayed due to limited screen space. The third and fourth groups are therefore hidden and the option 146 can be selected to display the third and fourth groups. A scroll bar 148 can be used to navigate to the third and fourth groups.

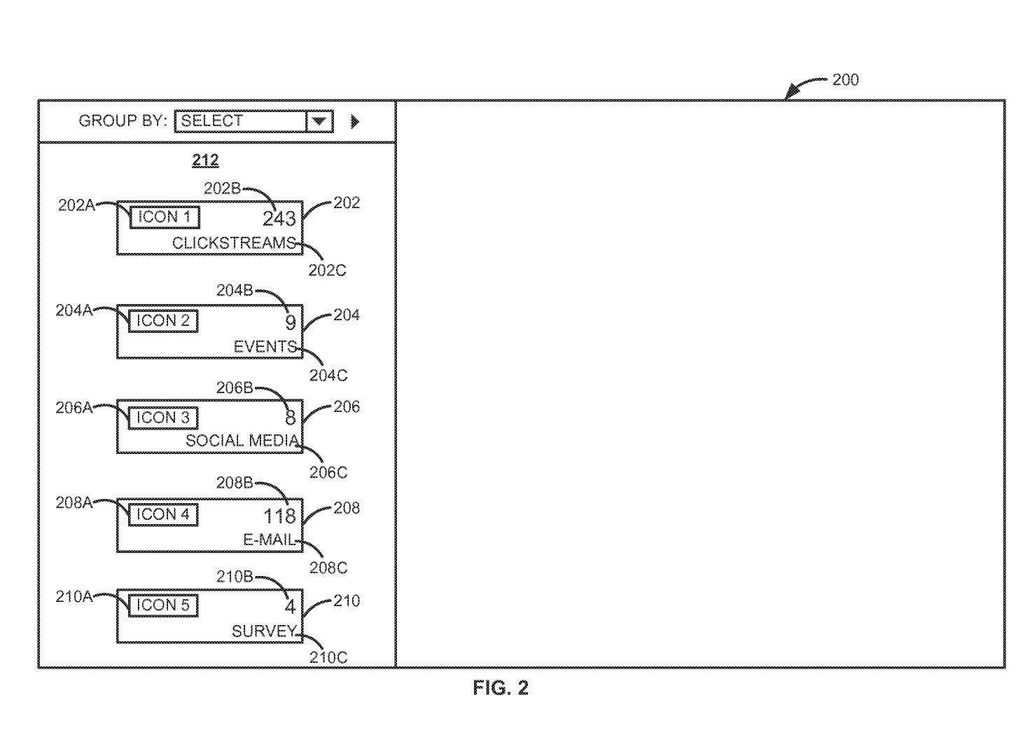

FIG. 2 illustrates a block diagram of an embodiment of a graphical user interface 200. The GUI 200 includes graphical filter elements 202-210 in the first region 212 of the GUI. The graphical filter elements 202-210 correspond to content types including clickstreams, events, social media, email, and surveys. The first graphical filter element 202 corresponds to clickstreams, the second graphical filter element 204 corresponds to events, the third graphical filter element 206 corresponds to social media, the fourth graphical filter element 208 corresponds to emails, and the fifth graphical filter element 210 corresponds to surveys.

The first graphical filter element 202 includes an icon 202A to represent clickstreams, numeric information 202B about the clickstreams, and name 202C of the content type, i.e., “clickstreams.” Numeric information 202B about the clickstreams can include the number of clickstream data elements for a website or a software application. The second graphical filter element 204 includes an icon 204A to represent events, numeric information 204B containing number of events, and name 204C of the content type, i.e., “events”. The third graphical filter element 206 includes an icon 206A to represent a social media channel, numeric information 206B, and name 206C of the content type, i.e., “social media”. The numeric information 206B of the third graphical filter element 206 can include data elements such as “likes” for a particular user or an organization. The fourth graphical filter element 208 includes an icon 208A to represent email, numeric information 208B containing number of related emails, and name 208C of the content type, i.e., “emails”. The fifth graphical filter element 210 includes an icon 210A to represent surveys, numeric information 210B about the number of completed surveys, and name 210C of the content type, i.e., “surveys”.

A user can select one or more graphical filter elements. Following selection, a data request is initiated and content related to selected graphical filter elements is retrieved and displayed. In one example, an Open Data Protocol (OData) can be used access content. However, any data access protocols can be used to access and retrieve content. Content can be spread across different sources and appropriate data access protocols can be used to retrieve data.

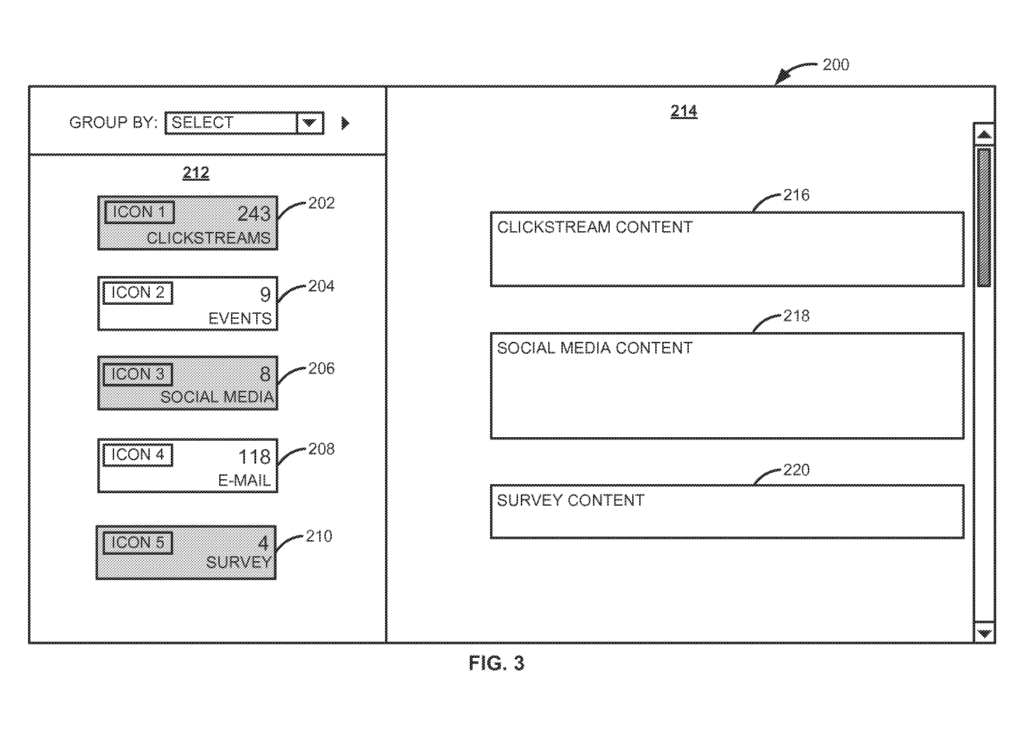

Referring to FIG. 3, consider that the first graphical filter element 202, the third graphical filter element 206, and the fifth graphical filter element 210 are selected. This will initiate data requests to retrieve content related to clickstreams, social media, and surveys. The respective content is then retrieved and presented in the second region 214 of the GUI 200. The content is displayed in respective demarcated content regions. The clickstream content is displayed in a first demarcated content region 216, the social media content is displayed in a second demarcated content region 218, and the survey content is displayed in a third demarcated content region 220. Since no grouping option is selected, the content in the second region 214 is not grouped.

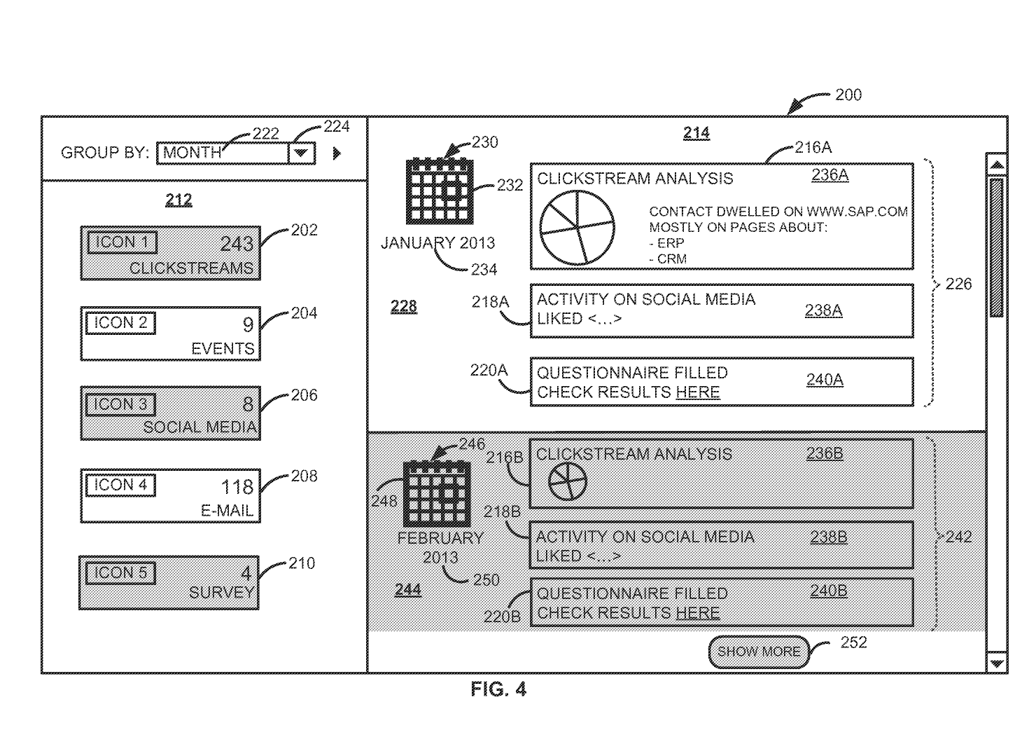

Referring to FIG. 4, the grouping option “month” 222 is shown as selected in the GUI. After this selection is made by the user using the grouping option selector 224, the content in the second region 214 is divided into groups. In one embodiment, the groups are arranged in chronological order. The groups start from January assuming that the content is available from January. The first group 226 corresponds to January and is displayed in the first portion 228 of the second region 214. The curly brackets in the figure are shown to represent the groups but are not part of the GUI. A first group indicator 230 includes a calendar image 232 and name of the month 234, i.e., January. The content in the first group 226 is displayed in demarcated content regions. Since the first graphical filter element 202, the third graphical filter element 206, and the fifth graphical filter element 210 are selected, three demarcated content regions are displayed in the first group 226. Clickstream content is displayed in a first demarcated content region 216A of the first portion 228. In one example embodiment, clickstream content 236A can include a chart and details about the time spent on a website. Social media content is displayed in a second demarcated content region 218A of the first portion 228. In one example embodiment, social media content 238A can include number of likes for a contact, organization, or a product. Survey content is displayed in a third demarcated content region 220A of the first portion 218. In one example embodiment, survey content 240A can include a link that directs to the results of the survey.

The second group 242 corresponds to February and is displayed in the second portion 244 of the second region 214. A second group indicator 246 includes a calendar image 248 and name of the month 250, i.e., February. Clickstream content 236B corresponding to February is displayed in a first demarcated content region 216B of the second portion 244. Social media content 238B is displayed in a second demarcated content region 218B of the second portion 244. Survey content 240B is displayed in a third demarcated content region 220B of the second portion 244. There can be more groups corresponding to March, April, etc. Due to limited screen space, these groups can be hidden and an option 252 to show the hidden groups is provided.

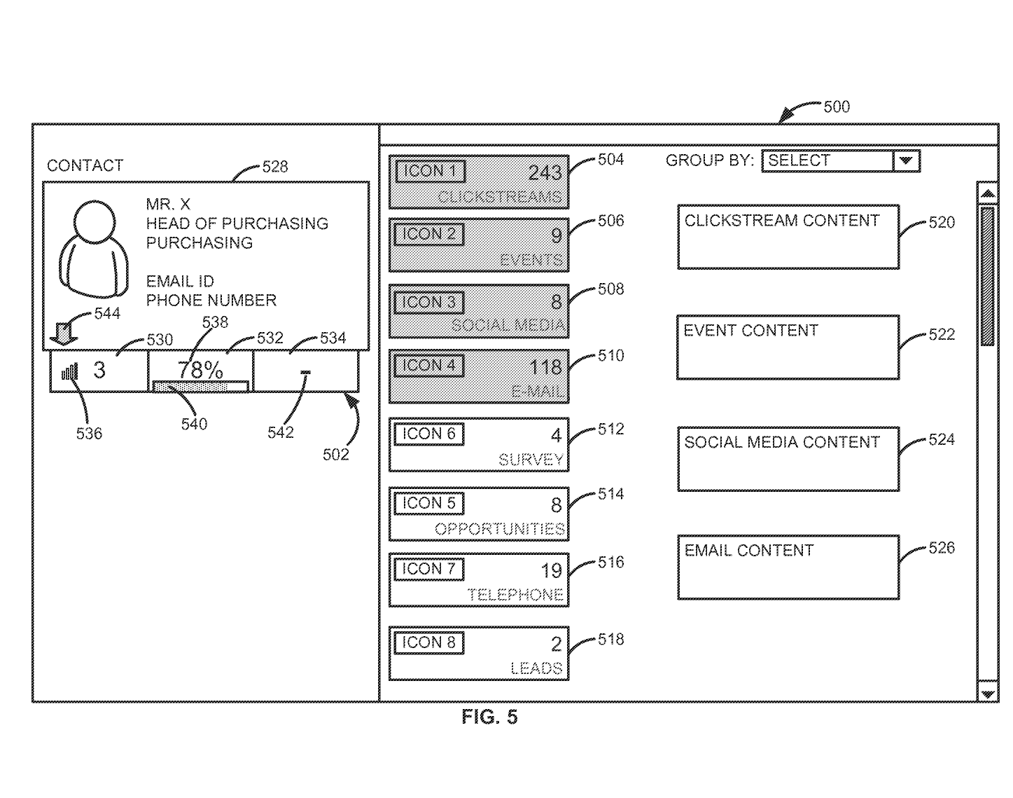

FIG. 5 illustrates an embodiment of a graphical user interface 500 including a graphical indicator 502. In this embodiment, the graphical filter elements include clickstreams element 504, events element 506, social media element 508, email element 510, survey element 512, opportunities element 514, telephone element 516, and leads element 518. In one embodiment, opportunities element 514, telephone element 516, and leads element 518 are channels that are configured by a user. Telephone element corresponds to number of calls made to and/or made by a party. Leads can be created for a business partner or a prospective customer. Leads can be used to qualify the level of interest by a business partner. Opportunities can correspond to sales opportunities and leads can be converted into opportunities. The clickstreams element 504, events element 506, social media element 508, and email element 510 are shown as selected and content is displayed in respective demarcated content regions 520, 522, 524, and 526. The graphical indicator 502 represents a condensed overview of performance indicators. In one example embodiment, the GUI 500 can correspond to a specific account belonging to a person, department, or an organization. Considering that the account belongs to a person, for example, the details of the person are presented in a business card format 528 in the GUI 500.

The graphical indicator 502 includes sections representing a condensed overview of key performance indicators (KPI) of the person. The sections in the graphical indicator correspond to respective KPIs. In the GUI 500, three sections are shown. A first section 530 corresponds to a first KPI, a second section 532 corresponds to a second KPI, and a third section 534 corresponds to a third KPI. A section represents corresponding performance indicator in a condensed form such that an overview of the performance indicators can be obtained in a less screen space. Condensed form can include text, image, color, background, micro graphical elements, etc., or any combination thereof. For example, the first section 530 includes a number “3” and a rating bar 536 with a scale up to four. A user viewing at this section can quickly know the rating for the first KPI is 3 out of 4. The second section 532 includes percentage 538 and a color-coded bar 540 representing the percentage 538 in shaded region. The third section 534 includes a “negative” symbol 542 (e.g., in red color) indicating low performance for the third KPI. A user viewing at the third section 534 can, in a quick glance, know the performance for the third KPI is low.

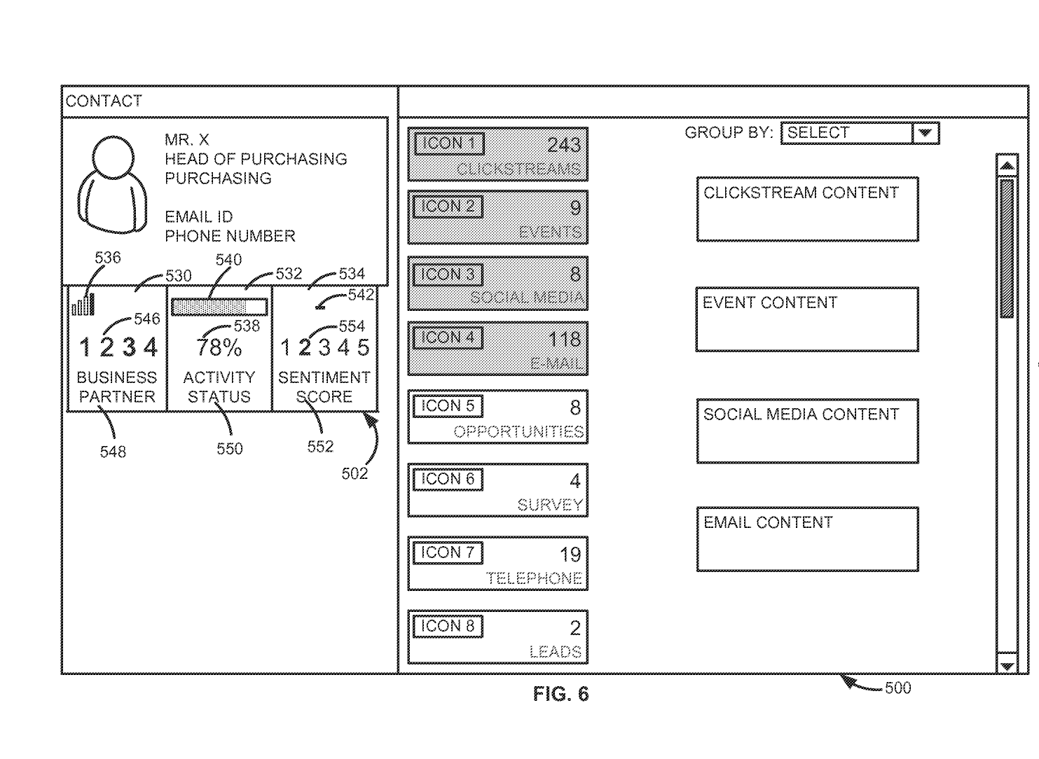

The GUI 500 further includes an option 544 to expand the graphical indicator 502. After the option 544 is selected, the graphical indicator 502 is expanded and additional details of the KPIs are displayed. FIG. 6 shows the GUI 500 with expanded graphical indicator 502. The sections 530, 532, and 534 of the graphical indicator 502 are expanded and more details about respective KPIs are displayed. In addition to the rating bar 536, the expanded first section 530 includes name 546 of the first KPI, i.e., Business Partner, and a rating scale 548. The expanded second section 532 includes name 550 of the second KPI, i.e., activity status, in addition to the percentage 538 and the color-coded bar 540. The expanded third section 534 includes name 552 of the third KPI, i.e., sentiment score, and a rating scale 554 in addition to the “negative” symbol 542.

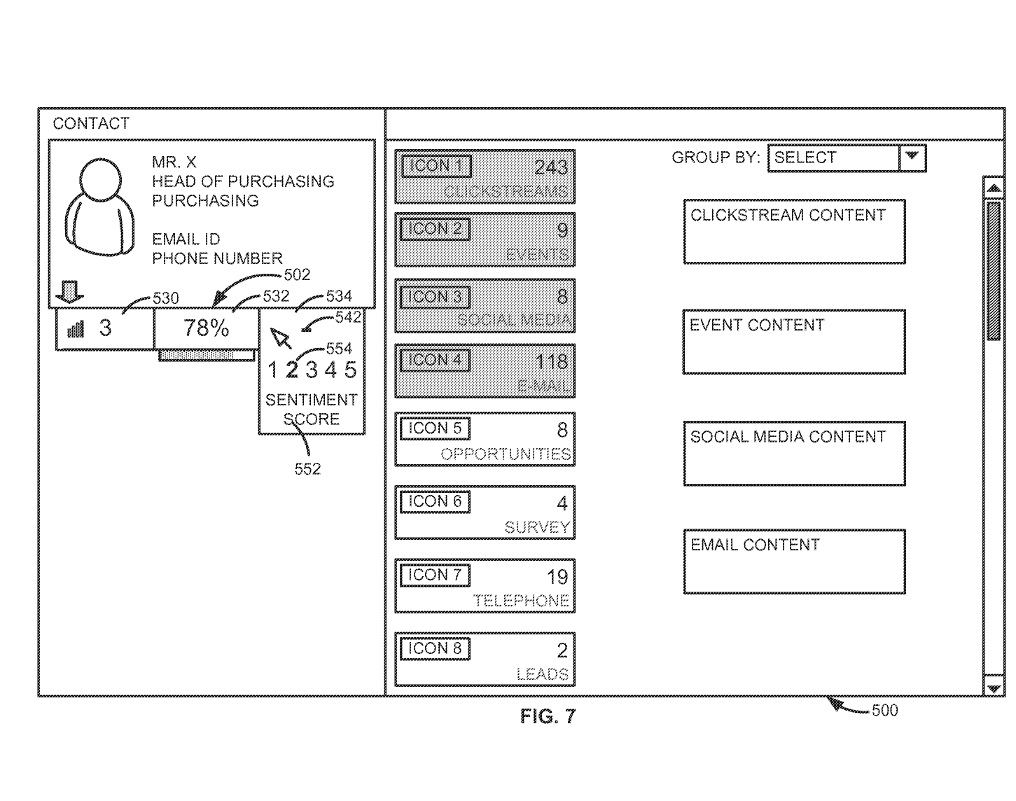

Referring to FIG. 7, in one embodiment, the sections 530, 532, and 534 of the graphical indicator 502 are individually selectable. Upon selection of a section, the selected section is expanded to display details of corresponding performance indicator. For example, if the third section 534 is selected, details of the third KPI including the “negative” symbol 542, the name 552 of the third KPI, and the rating scale 554 are displayed. The selection can be made by clicking on the third section 534. In one embodiment, the selection can be made by placing the cursor on the third section 534. Once the cursor is moved away from the third section 534, the details of the third KPI are collapsed and only the “negative” symbol 542 is displayed.

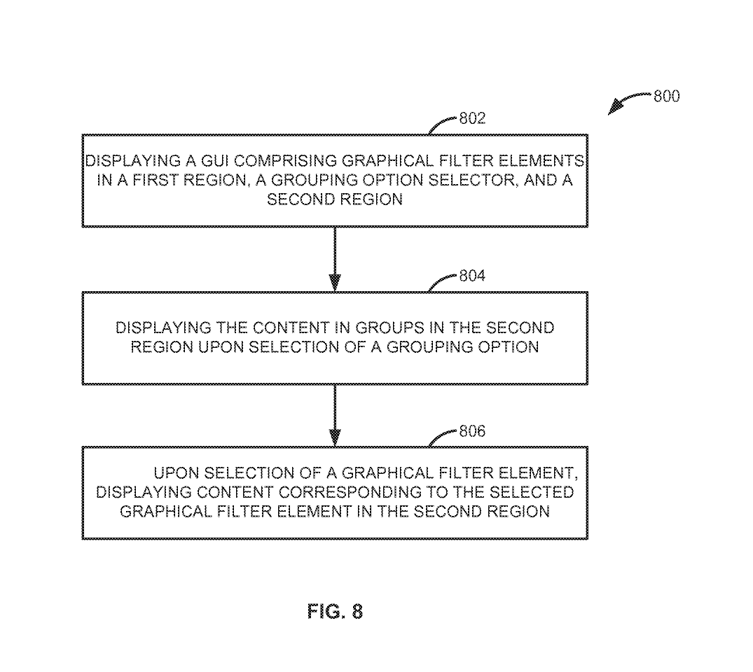

FIG. 8 illustrates an embodiment of a method 800 for displaying data. At 802, a graphical user interface (GUI) is displayed. The GUI includes a first region including graphical filter elements corresponding to respective content types. A graphical filter element comprises a unique icon representing corresponding content type, numeric information related to the corresponding content type, and a name of the corresponding content type. The GUI further includes a grouping option selector and a second region for displaying content. At 804, the content is displayed in groups in the second region upon selection of a grouping option using the grouping option selector. The groups are ordered in the second region and group indicators represent respective groups in the second region. At 806, upon selection of a particular graphical filter element, content corresponding to the selected graphical filter element is displayed in the second region. The content in the second region is displayed in demarcated content regions corresponding to respective content types.

In one embodiment, a user can select graphical filter elements first and, following which, can select a grouping option. In such scenario, the content in the second region is first displayed in the demarcated content regions, without any grouping. After a grouping option is selected, the content in the second region is then divided into groups. In another embodiment, a user can select a grouping option first and, following which, can select graphical filter elements. In such scenario, the content in the second region is displayed in groups, with a group including demarcated content regions corresponding to respective content types. After the graphical filter elements are selected, the content in the second region, i.e., in the groups, is then filtered.

Although only some content types such as clickstreams, events, social media, email, and surveys are used for explanation, it should be understood that other content types also fall within the scope of the embodiments. Content can from different data sources and channels. Content types can vary depending on the field and scenarios. Nevertheless, the above-described GUI embodiments are applicable in any field or scenarios to present information in a condensed and informative manner. Also, several UI development technologies or toolkits can be used to implement the embodiments described above.

The above-described embodiments provide an intuitive way of presenting data. Filters are typically provided using a drop-down menu. Also, filters are typically represented using only names. Filtering techniques typically involve providing a list of filters using a drop-down menu. In such techniques, filters can be identified by names and, upon selection of filters, data is filtered and presented. But there is no further information about the filters themselves. The graphical filter elements provide intuitive information about the filters. The unique icon, numeric information and name of the filter in a graphical filter element provide a concise overview of the filter. Also, embodiments of grouping the content, presenting the content in demarcated content regions, and presenting the performance indicators make proper use of the screen space while at the same time providing structured information.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

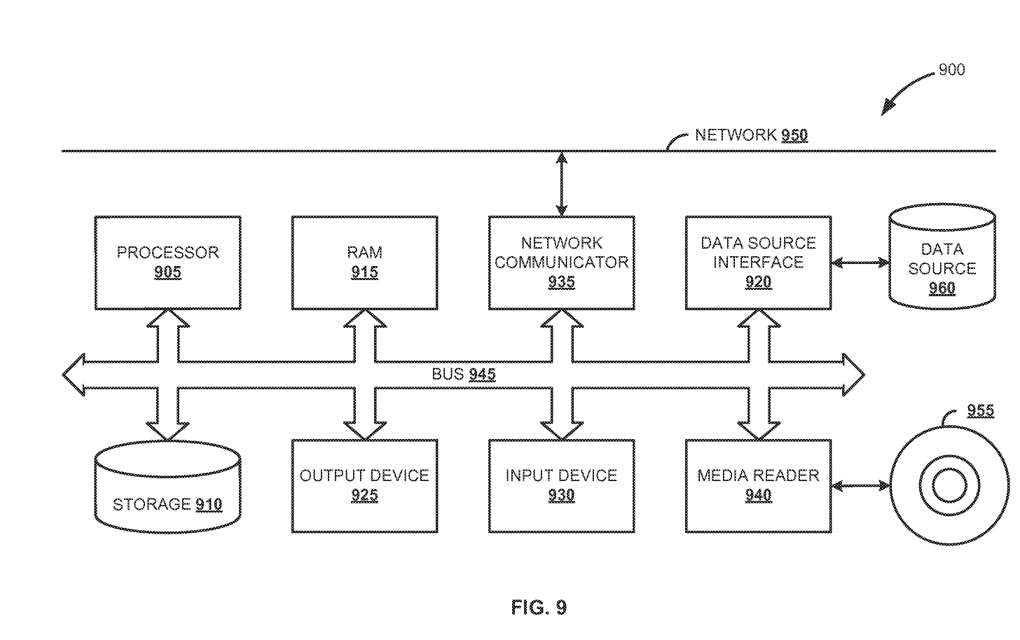

FIG. 9 is a block diagram of an exemplary computer system 900. The computer system 900 includes a processor 905 that executes software instructions or code stored on a computer readable storage medium 955 to perform the above-illustrated methods. The processor 905 can include a plurality of cores. The computer system 900 includes a media reader 940 to read the instructions from the computer readable storage medium 955 and store the instructions in storage 910 or in random access memory (RAM) 915. The storage 910 provides a large space for keeping static data where at least some instructions could be stored for later execution. According to some embodiments, such as some in-memory computing system embodiments, the RAM 915 can have sufficient storage capacity to store much of the data required for processing in the RAM 915 instead of in the storage 910. In some embodiments, all of the data required for processing may be stored in the RAM 915. The stored instructions may be further compiled to generate other representations of the instructions and dynamically stored in the RAM 915. The processor 905 reads instructions from the RAM 915 and performs actions as instructed. According to one embodiment, the computer system 900 further includes an output device 925 (e.g., a display) to provide at least some of the results of the execution as output including, but not limited to, visual information to users and an input device 930 to provide a user or another device with means for entering data and/or otherwise interact with the computer system 900. Each of these output devices 925 and input devices 930 could be joined by one or more additional peripherals to further expand the capabilities of the computer system 900. A network communicator 935 may be provided to connect the computer system 900 to a network 950 and in turn to other devices connected to the network 950 including other clients, servers, data stores, and interfaces, for instance. The modules of the computer system 900 are interconnected via a bus 945. Computer system 900 includes a data source interface 920 to access data source 960. The data source 960 can be accessed via one or more abstraction layers implemented in hardware or software. For example, the data source 960 may be accessed by network 950. In some embodiments the data source 960 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the invention are described herein for illustrative purposes, various equivalent modifications are possible within the scope of the invention, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer readable storage medium to tangibly store instructions, which when executed by a computer, cause the computer to perform operations comprising:
displaying a graphical user interface (GUI) comprising:
a first region including a plurality of graphical filter elements corresponding to respective content types, wherein a graphical filter element comprises a unique icon representing corresponding content type, numeric information related to the corresponding content type, and a name of the corresponding content type;
a grouping option selector; and
a second region for displaying content;
upon selection of a grouping option using the grouping option selector, displaying the content in groups in the second region, wherein the groups are ordered in the second region and group indicators represent respective groups in the second region; and
upon selection of a particular graphical filter element, displaying content corresponding to the selected graphical filter element in the second region, wherein the content in the second region is displayed in demarcated content regions corresponding to respective content types.

2. The non-transitory computer readable storage medium of claim 1, comprising instructions, which when executed by the computer, causes the computer to perform operations further comprising:
when the content in the groups cannot be fully displayed in the second region, hide one or more of the groups; and
provide an option to show the hidden groups.

3. The non-transitory computer readable storage medium of claim 1, wherein the graphical filter elements comprise user interface (UI) tiles and the groups are arranged in respective portions of the second region.

4. The non-transitory computer readable storage medium of claim 3, wherein the group indicators are displayed in the respective portions of the second region and the respective portions are represented using different UI backgrounds to distinguish the groups.

5. The non-transitory computer readable storage medium of claim 1, wherein the graphical filter elements are arranged in a linear order in the first region and the groups are arranged in a sequential order in the second region.

6. The non-transitory computer readable storage medium of claim 1, wherein:
the GUI further comprises:
a graphical indicator comprising sections representing condensed overview of performance indicators; and
an option to expand the graphical indicator for displaying details of the performance indicators; and
the instructions, which when executed by the computer, causes the computer to perform operations further comprising:
upon selection of a section, expanding the selected section and display information related to a corresponding performance indicator.

7. The non-transitory computer readable storage medium of claim 1, further comprising instructions which when executed by the computer further causes the computer to:
highlight the selected graphical filter element.

8. A computer-implemented method for displaying data, the method comprising:
displaying a graphical user interface (GUI) comprising:
a first region including a plurality of graphical filter elements corresponding to respective content types, wherein a graphical filter element comprises a unique icon representing corresponding content type, numeric information related to the corresponding content type, and a name of the corresponding content type;
a grouping option selector; and
a second region for displaying content;
upon selection of a grouping option using the grouping option selector, displaying the content in groups in the second region, wherein the groups are ordered in the second region and group indicators represent respective groups in the second region; and
upon selection of a particular graphical filter element, displaying content corresponding to the selected graphical filter element in the second region, wherein the content in the second region is displayed in demarcated content regions corresponding to respective content types.

9. The method of claim 8, further comprising:
when the content in the groups cannot be fully displayed in the second region, hide one or more of the groups; and
provide an option to show the hidden groups.

10. The method of claim 8, wherein the graphical filter elements comprise user interface (UI) tiles and the groups are arranged in respective portions of the second region.

11. The method of claim 10, wherein the group indicators are displayed in the respective portions of the second region and the respective portions are represented using different UI backgrounds to distinguish the groups.

12. The method of claim 8, wherein the graphical filter elements are arranged in a linear order in the first region and the groups are arranged in a sequential order in the second region.

13. The method of claim 8, wherein:
the GUI further comprises:
a graphical indicator comprising sections representing condensed overview of performance indicators; and
an option to expand the graphical indicator for displaying details of the performance indicators; and
the method further comprising:
upon selection of a section, expanding the selected section and display information related to a corresponding performance indicator.

14. The method of claim 8, further comprising:
highlight the selected graphical filter element.

15. A computer system for displaying data, comprising:
a computer memory to store program code; and
a processor to execute the program code to perform operations comprising:
displaying a graphical user interface (GUI) comprising:
a first region including a plurality of graphical filter elements corresponding to respective content types, wherein a graphical filter element comprises a unique icon representing corresponding content type, numeric information related to the corresponding content type, and a name of the corresponding content type;
a grouping option selector; and
a second region for displaying content;
upon selection of a grouping option using the grouping option selector, displaying the content in groups in the second region, wherein the groups are ordered in the second region and group indicators represent respective groups in the second region; and
upon selection of a particular graphical filter element, displaying content corresponding to the selected graphical filter element in the second region, wherein the content in the second region is displayed in demarcated content regions corresponding to respective content types.

16. The system of claim 15, wherein the processor executes the program code to perform operations further comprising:
when the content in the groups cannot be fully displayed in the second region, hide one or more of the groups; and
provide an option to show the hidden groups.

17. The system of claim 15, wherein the graphical filter elements comprise user interface (UI) tiles and the groups are arranged in respective portions of the second region.

18. The system of claim 17, wherein the group indicators are displayed in the respective portions of the second region and the respective portions are represented using different UI backgrounds to distinguish the groups.

19. The system of claim 15, wherein the graphical filter elements are arranged in a linear order in the first region and the groups are arranged in a sequential order in the second region.

20. The system of claim 15, wherein:
the GUI further comprises:
a graphical indicator comprising sections representing condensed overview of performance indicators; and
an option to expand the graphical indicator for displaying details of the performance indicators; and
the processor executes the program code to perform operations further comprising:
upon selection of a section, expanding the selected section and display information related to a corresponding performance indicator.
